(19) United States
(12) Patent Application Publication
(10) Pub. No.: US 2016/0073039 A1
(43) Pub. Date: Mar. 10, 2016

(54) SYSTEM AND METHOD FOR AUTO-ADJUST RATE OF ZOOM FEATURE FOR DIGITAL VIDEO

(71) Applicant: Sony Corporation, Tokyo (JP)

(72) Inventors: Ken Lee, Taipei (TW); Jungle Chu, Taipei (TW)

(21) Appl. No.: 14/479,731

(22) Filed: Sep. 8, 2014

(51) Int. Cl. H04N 5/262; G06K 9/00; G06K 9/20; G06K 9/22; H04N 5/232; G06K 9/32

(52) U.S. Cl. CPC H04N 5/2628; H04N 5/23219; H04N 5/23293; G06K 9/3233; G06K 9/2081; G06K 9/22; G06K 9/00221

(57) ABSTRACT

An electronic device includes a camera assembly configured to capture a digital video, a display for rendering the digital video, and a controller. The controller is configured to track a target subject matter as the target subject matter moves within the digital video, receive a zoom factor corresponding to a display proportion of the target subject matter in the display relative to an entire display space, and control a zoom function to render the digital video in the display such that the target subject matter is consistently displayed in accordance with the zoom factor. The zoom factor may include a first zoom factor and a second zoom factor. The controller switches from controlling the zoom function in accordance with the first zoom factor to the second zoom factor in response to a trigger event. The control of the zoom function may be performed by automatically adjusting the zoom rate.

### TECHNICAL FIELD OF THE INVENTION

The present invention relates to electronic devices that render digital images, and more particularly to a system and methods for automatically adjusting a rate of zoom when taking a digital video.

### DESCRIPTION OF THE RELATED ART

Contemporary digital video cameras typically include a zoom feature. As digital imaging circuitry has become less expensive, various types of other portable devices, including mobile telephones, portable data assistants (PDAs), tablet computers and other mobile electronic devices often include an embedded image capture device (e.g. digital camera) that has the capability of imaging digital video.

Generally, digital video cameras have a zoom function by which a user can zoom in or zoom out to desirably center or otherwise desirably locate the subject being imaged within the image display. Two types of zoom function generally are used in various types of digital cameras. First, an optical zoom function may be employed by physically moving the positions of the camera lenses relative to each other. The zoom range of the optical zoom function may be limited, however, by the size of the camera device. The larger the range of permissible motion of the camera lenses, the greater the range of the optical zoom. It is also desirable, however, that the camera device be as portable as possible, and therefore small, which restricts the space that can be allocated to the optical zoom function. A second type of zoom function is referred to as a digital zoom. In digital zoom, the zoom function is achieved through image processing of the digital image. Digital zoom does not require additional space as in optical zoom, but digital zoom (particularly zooming in) can result in decreased resolution as the pixel size effectively becomes enlarged. Accordingly, it is common to combine digital and optical zoom functionality so as to balance the zoom range and capability with the drawbacks of each type of zoom function.

A user can generally perform a zoom function with ease as to a still digital image. Camera devices generally may have dedicated command functions, buttons, touch screen keys, or menu options for zoom functionality that are easy to use. Use of the zoom functionality, however, becomes more difficult for digital video, as the subject matter may be moving. If a user desires a subject of a digital video to be centered or otherwise constantly located at a desired image distance, it takes a great deal of camera skill to maintain the desired image location within the image display. For example, as a subject moves a user must attempt to operate the zoom function of the camera to maintain a desired imaging of the subject, while keeping the camera steady and directed at the subject. This is a highly difficult camera operation for all but the most coordinated and talented camera operators. The result of manual zoom functioning in a digital video often is a video in which the zoom operation is not smooth, but increases or decreases suddenly in a jerking fashion, and/or the subject is not properly located within the image display.

### SUMMARY

Accordingly, there is a need in the art for an improved system and methods for the operation of zoom functionality when imaging a digital video. In exemplary embodiments of the invention, a target subject matter is tracked as the target subject matter moves within the digital video. A zoom factor is inputted, which corresponds to a display proportion of the target subject matter in the display relative to an entire display space. A zoom function is controlled to render the digital video in the display such that the target subject matter is constantly displayed in accordance with the zoom factor. The control of the zoom function may be performed by automatically adjusting the zoom rate. By automatically controlling the zoom function in this fashion, the deficiencies of conventional manual zoom operations are avoided.

The zoom function is automatically adjusted so as to maintain the target subject matter proportionally located in the display in accordance with the zoom factor. For example, if the zoom factor is set at fifty percent, the zoom function will operate automatically to maintain the proportion of the display of the target subject matter to fifty percent of the entire display space. Accordingly, if the object is farther away from the camera device such that the display of the target subject matter encompasses less than fifty percent of the display, the zoom function automatically will adjust the zoom, such as by zooming in, until the proportional display of the target subject matter reaches fifty percent of the display in accordance with the zoom factor. Such proportional display of the subject matter will be maintained within the digital video even as the target subject matter moves. For example, when the target subject matter moves toward the electronic device, the zoom function automatically will adjust the zoom, such as by reducing the zoom rate, so as to maintain the proportional display of the target subject matter in accordance with the zoom factor. Conversely, when the target subject matter moves away from the electronic device, the zoom function automatically will adjust the zoom, such as by increasing the zoom rate, again so as to maintain the proportional display of the target subject matter in accordance with the zoom factor.

An aspect of the invention, therefore, is an electronic device. In exemplary embodiments, the electronic device includes a camera assembly configured to capture a digital video, a display for rendering the digital video, and a controller. The controller is configured to: track a target subject matter as the target subject matter moves within the digital video, receive a zoom factor corresponding to a display proportion of the target subject matter in the display relative to an entire display space of the display, and control a zoom function to render the digital video in the display such that the target subject matter is displayed in accordance with the zoom factor as the target subject matter moves within the digital video.

In an exemplary embodiment of the electronic device, the electronic device further includes an input interface configured to receive a user input of the zoom factor.

In an exemplary embodiment of the electronic device, the input interface comprises a touch screen on the display, and the touch screen is configured to receive the user input of the zoom factor.

In an exemplary embodiment of the electronic device, the touch screen further is configured to receive a user input identifying the target subject matter.

In an exemplary embodiment of the electronic device, the input interface comprises a keypad, and the keypad is configured to receive the user input of the zoom factor.

In an exemplary embodiment of the electronic device, the zoom factor is a percentage of display space of the display that the target subject matter is to occupy relative to an entire display space of the display.

Another aspect of the invention is a method of automatically performing a zoom function for a digital video. In exemplary embodiments, the method includes the steps of: rendering a digital video in a display of an electronic device; identifying a target subject matter in the digital video; receiving an input of a zoom factor corresponding to a display proportion of the target subject matter in the display relative to an entire display space of the display; tracking the target subject matter as the target subject matter moves in the digital video; and controlling a zoom function to render the digital video in the display such that the target subject matter is displayed in accordance with the zoom factor as the target subject matter moves within the digital video.

In an exemplary embodiment of the method of automatically performing a zoom function, the zoom factor is a percentage of display space of the display that the target subject matter is to occupy relative to an entire display space of the display.

In an exemplary embodiment of the method of automatically performing a zoom function, the method further includes displaying an indicator on the display to indicate the target subject matter.

In an exemplary embodiment of the method of automatically performing a zoom function, the zoom factor is received by setting the zoom factor independently of rendering the digital video.

In an exemplary embodiment of the method of automatically performing a zoom function, the zoom factor is received by setting the zoom factor while rendering the digital video using a two-finger pinch zoom command on a touch screen display.

In an exemplary embodiment of the method of automatically performing a zoom function, controlling the zoom function to render the digital video in the display such that the target subject matter is displayed in accordance with the zoom factor as the target subject matter moves within the digital video comprises automatically adjusting the zoom rate.

In an exemplary embodiment of the method of automatically performing a zoom function, controlling the zoom function comprises either of zooming in or zooming out to render the digital video in the display such that the target subject matter is displayed in accordance with the zoom factor as the target subject matter moves within the digital video.

In an exemplary embodiment of the method of automatically performing a zoom function, the zoom factor comprises a first zoom factor and a second zoom factor different from the first zoom factor, the method further comprising switching from controlling the zoom function in accordance with the first zoom factor to controlling the zoom function in accordance with the second zoom factor in response to a trigger event.

In an exemplary embodiment of the method of automatically performing a zoom function, the trigger event is controlling the zoom function at a predefined zoom rate.

In an exemplary embodiment of the method of automatically performing a zoom function, the predefined zoom rate is zero.

In an exemplary embodiment of the method of automatically performing a zoom function, the first zoom factor is fifty percent of the entire display space and the second zoom factor is between seventy and ninety percent of the entire display space.

In an exemplary embodiment of the method of automatically performing a zoom function, the subject matter is a face of a person, and the tracking is performed by face detection processing.

Another aspect of the invention is a non-transitory computer readable medium storing executable code that is executed by a controller. In exemplary embodiments, the controller executes the code to perform the steps of: rendering a digital video in a display of an electronic device; identifying a target subject matter in the digital video; receiving an input of a zoom factor corresponding to a display proportion of the target subject matter in the display relative to an entire display space of the display; tracking the target subject matter as the target subject matter moves in the digital video; and controlling a zoom function to render the digital video in the display such that the target subject matter is displayed in accordance with the zoom factor as the target subject matter moves within the digital video.

In an exemplary embodiment of the non-transitory computer readable medium, the zoom factor comprises a first zoom factor and a second zoom factor different from the first zoom factor, and the controller executes the code to switch from controlling the zoom function in accordance with the first zoom factor to controlling the zoom function in accordance with the second zoom factor in response to a trigger event.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic front view of a mobile telephone as an exemplary electronic device for use in accordance with embodiments of the present invention.

FIG. 2 is a schematic block diagram of operative portions of the mobile telephone of FIG. 1.

FIG. 3 is a flowchart chart diagram depicting an overview of an exemplary method of automatically performing a zoom function for a digital video.

FIG. 4 is a schematic diagram of a communications system in which the mobile telephone of FIG. 1 may operate.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

In the illustrated embodiments, a digital video may be rendered and manipulated as part of the operation of a mobile telephone. It will be appreciated that aspects of the invention are not intended to be limited to the context of a mobile telephone and may relate to any type of appropriate electronic device having a digital video function, examples of which include a stand-alone digital camera, a media player, a gaming device, a laptop or tablet computer, or similar. For purposes of the description herein, the term “electronic device” also may include portable radio communication equipment. The term “portable radio communication equipment,” which sometimes is referred to as a “mobile radio terminal,” includes all equipment such as mobile telephones, pagers, communicators, electronic organizers, personal digital assistants (PDAs), smartphones, tablets, and any communication apparatus or the like. All such devices may be operated in accordance with the principles described herein.

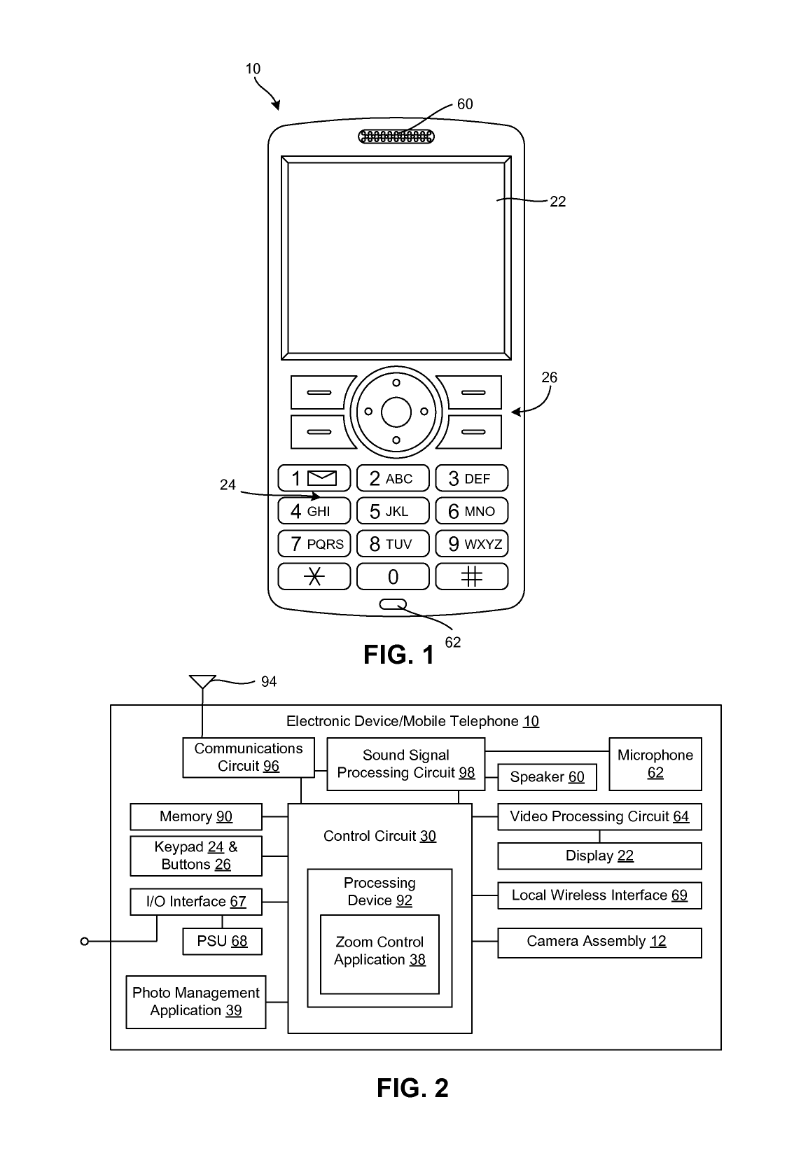

FIG. 1 is a schematic diagram of a front view of an electronic device 10 in the form of a mobile telephone, and FIG. 2 is a schematic block diagram of operative portions of the electronic device/mobile telephone 10. The exemplary mobile telephone is depicted as having a “block” or “brick” configuration, although the mobile telephone may have other configurations, such as, for example, a clamshell, pivot, swivel, and/or sliding cover configuration as are known in the art.

The electronic device 10 includes a display 22 for displaying information to a user regarding the various features and operating state of the mobile telephone 10. Display 22 also displays visual content received by the mobile telephone 10 and/or retrieved from a memory 90. As part of the present invention, display 22 may render and display digital images, and digital video images in particular. In one embodiment, the display 22 may function as an electronic viewfinder for a camera assembly 12 for such digital images, including a digital video.

An input device is provided in the form of a keypad 24 including buttons 26, which provides for a variety of user input operations. For example, keypad 24/buttons 26 typically include alphanumeric keys for allowing entry of alphanumeric information such as telephone numbers, phone lists, contact information, notes, etc. In addition, keypad 24/buttons 26 typically includes special function keys such as a “send” key for initiating or answering a call, and others. The special function keys may also include various keys for navigation and selection operations to access menu information within the mobile telephone 10. As shown in FIG. 1, for example, the special function keys may include a five-way navigational ring containing four directional surfaces and a center button that may be used as an “enter key” selection button. Some or all of the keys may be used in conjunction with the display as soft keys. Accordingly, keys or key-like functionality also may be embodied as a touch screen associated with the display 22.

Referring additionally to FIG. 2, the electronic device 10 may include a camera assembly 12 configured to capture digital images, including digital still images and digital video. The camera assembly 12 may include various lens assembles, image sensors, image processing applications, focusing apparatuses, and the like as are conventional in digital camera systems. The camera assembly 12 may be suitable for both still and digital video imaging. As part of such imaging, the camera assembly 12 may be configured to perform zooming operations, encompassing optical and/or digital zooming as are known in the art and described previously. In addition, keypad 24 and/or buttons 26 may be associated with aspects of the camera system 12. For example, one of the keys from the keypad 24 or one of the buttons 26 may be associated with entering a camera mode of operation, such as by selection from a conventional menu or by pushing a dedicated button for the camera function. One or more of such keys or buttons may be a shutter key that the user may depress to command the taking of a photograph, or a key to initiate and otherwise control the recording of a digital video. The camera assembly also may be associated with one or more photo management applications 39, which permits various operations relating to the organization and manipulation of digital images and video as are known in the art.

In exemplary embodiments, one or more of the buttons 26 may operate as a dedicated zoom function when the electronic device 10 is operating a camera mode. Such dedicated buttons may be employed to zoom in or zoom out as desired to maintain subject matter properly located as desired within an image display. The operation of the zoom function may employ a combination of optical zoom with the camera lenses and digital zoom by image processing. Again, any of the keys or key-like functionality described with respect to functions of the camera assembly 12, including zoom operations, also may be performed using a touch screen associated with the display 22.

Referring again to FIG. 2, the electronic device 10 may include a primary control circuit 30 that is configured to carry out overall control of the functions and operations of the electronic device 10. The control circuit 30 may include a processing device 92, such as a CPU, microcontroller or microprocessor with integral memory capability.

Among their functions, to implement the features of the present invention, the control circuit 30 and/or processing device 92 may comprise a controller that may execute program code stored on a non-transitory computer readable medium embodied as a zoom control application 38. Application 38 may be a stand-alone software application or form a part of a software application that carries out additional tasks related to the electronic device 10. It will be apparent to a person having ordinary skill in the art of computer programming, and specifically in application programming for mobile telephones, servers or other electronic devices, how to program an electronic device to operate and carry out logical functions associated with the application 38. Accordingly, details as to specific programming code have been left out for the sake of brevity. In addition, application 38 and its various components may be embodied as hardware modules, firmware, or combinations thereof, or in combination with software code. Also, while the code may be executed by control circuit 30 in accordance with exemplary embodiments, such controller functionality could also be carried out via dedicated hardware, firmware, software, or combinations thereof, without departing from the scope of the invention.

Zoom control application 38 may be employed to apply an automatic adjustment to the zoom in and zoom out functionality when taking a digital video, referred to herein at times as the “auto-adjust zoom rate function”. The auto-adjust zoom rate function operates to automatically perform zoom in and zoom out functions as warranted to maintain a desired location of an imaged subject within the display of a digital video on the display 22. Such desired location of the subject within the display is maintained even as the subject moves, as would be common when taking a digital video. The automatic nature of the auto-adjust zoom rate function overcomes the deficiencies of conventional zoom functions, in which the zoom in and zoom out commands must be manually performed by the user, which renders it difficult to perform a smooth zoom while maintaining the subject properly located within the digital video display.

An aspect of the invention, therefore, is an electronic device configured to perform the auto-adjust zoom rate function. In exemplary embodiments, the electronic device includes a camera assembly configured to capture a digital video, a display for rendering the digital video, and a controller. The controller is configured to track a target subject matter as the target subject matter moves within the digital video, receive a zoom factor corresponding to a display proportion of the target subject matter in the display relative to an entire display space, and control a zoom function to render the digital video in the display such that the target subject matter is constantly displayed in accordance with the zoom factor. The control of the zoom function may be performed by automatically adjusting the zoom rate.

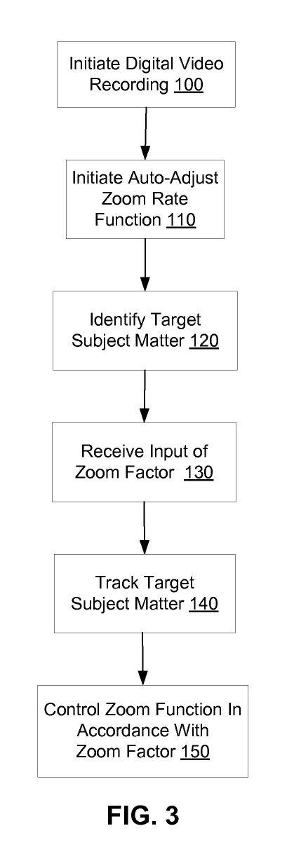

FIG. 3 is a flowchart chart diagram depicting an overview of an exemplary method of automatically performing a zoom function for a digital video. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention. As indicated, the method depicted in FIG. 3 represents an overview, and additional details are provided in connection with examples set forth below.

The method may begin at step 100 at which a digital video recording is initiated using the digital camera functionality referenced above. As a result, a digital video is rendered in a display of an electronic device, such as the display 22 of electronic device 10. At step 110, the electronic device may receive an input to initiate the auto-adjust zoom rate function, such as by dedicated key command, menu selection, or any suitable means.

As referenced above, the electronic device 10 may include an input interface in the form of a keypad 24 including key buttons 26. The input interface additionally or alternatively may be embodied as a touch screen associated with the display 22. The input interface may be employed to provide user inputs to the electronic device 10 associated with performing the auto-adjust zoom rate function.

Referring again to FIG. 3, therefore, at step 120 the electronic device identifies target subject matter. Such identification may be based on a user input to the input interface by which a user may select a target subject matter manually for tracking. For example, if the device display 22 has touch screen functionality, a user may select a target subject for tracking by touching the screen at the target subject location on the display. Automatic identification of target subject matter also may be performed. For example, the target subject matter of a digital video may include a person, and the person may be identified using face detection processing as is known in the art. Alternatively, a non-human target subject may be identified using object detection.

At step 130, the electronic device may receive an input of a zoom factor that determines an amount of zoom to maintain with respect to the tracked subject matter. In exemplary embodiments, the zoom factor may be set as a percentage or proportion of the display space that a target subject matter is to occupy relative to the entire display space. For example, a user may want the target subject matter to maintain fifty percent of the space of the display, or seventy percent of the display, or the like. Any suitable percentage may be selected and inputted using the input interface.

The zoom factor may be input manually as part of the camera settings independently of the actual taking of the digital video. Alternatively, a user may set the zoom factor based on the target subject matter while taking the digital video. For example, the user may employ a conventional zoom button to zoom in (or out) until the proportion of the subject matter in the display is commensurate with the desired zoom factor. In other words, when the user has zoomed to the desired level, such level is set by the system to be the zoom factor. In another example, if the device display 22 has touch screen functionality, a user may select a zoom factor by employing a zoom command on the touch screen, such as by using a two-finger pinch zoom command or swipe zoom command. The two-finger pinch zoom command is particularly suitable, by which thumb and forefinger swipe along the touch screen in a pinch or reverse pinch fashion respectively to zoom out or zoom in. As above with using a zoom button, the user may employ a touch screen zoom command until the proportion of the subject matter in the display is commensurate with the desired zoom factor. Once the user has zoomed to the desired level, such level is set by the device to be the zoom factor.

At step 140, the identified target subject matter may be tracked. Face and object tracking may be coupled with detection processing as is known in the art. In exemplary embodiments, an indicator may be displayed on the display to indicate the tracked subject matter. For example, a box indicator may be rendered on the display around the tracked subject matter.

At step 150, the zoom function is automatically controlled to render the digital image so as to maintain the target subject matter proportionally located in the display in accordance with the zoom factor. For example, if the zoom factor is set at fifty percent, the zoom function will be controlled automatically to maintain the proportion of the display of the target subject matter to fifty percent of the entire display space. Accordingly, if the object is farther away from the camera device such that the display of the target subject matter encompasses less than fifty percent of the display, the zoom function automatically will adjust the zoom, in this case by zooming in, until the proportional display of the target subject matter reaches fifty percent of the display in accordance with the zoom factor. Such proportional display of the subject matter will be maintained within the digital video even as the target subject matter moves. When the target subject matter moves toward the electronic device, the zoom function automatically will adjust the zoom, in this case by decreasing the zoom rate, so as to maintain the proportional display of the target subject matter in accordance with the zoom factor. Conversely, when the target subject matter moves away from the electronic device, the zoom function automatically will adjust the zoom, in this case by increasing the zoom rate, again so as to maintain the proportional display of the target subject matter in accordance with the zoom factor.

The above method of FIG. 3 is an overview of the auto-adjust zoom rate function. Additional details of auto-adjust zoom rate function are described with respect to an example in which it is supposed that the target subject matter is the face of a person. The auto-adjust zoom rate function may be performed by a controller, such as the control circuit 30 and/or processing device 92, executing program code stored on a non-transitory computer readable medium embodied as the zoom control application 38. The zoom control application 38 may be embodied in a memory integrally with the processing device 92 as seen in FIG. 2, or stored on a separate memory device such the memory 90.

In this example, the target subject matter, the face of a person, begins by being relatively far away from the camera device, such that the subject face may occupy ten percent of the display space or less. A user may first initiate the auto-adjust zoom rate function (FIG. 3, step 110). The subject face may be selected and tracked as the target subject matter automatically by face detection, or manually by the user, as described above with respect to FIG. 3, steps 120 and 140. The target subject face may now be tracked using conventional face detection processing. In this example, the user is deemed to select a zoom factor of fifty percent, meaning that the display of the target subject face is desired to occupy fifty percent of the total display space. As described above with respect to FIG. 3, step 130, the zoom factor may be preset as part of the camera settings, or set while taking the digital video by applying a zoom button or touch screen command to the target subject matter.

The zoom function is automatically controlled by the controller so as to maintain the target subject face fifty percent proportionally located in the display in accordance with the selected fifty percent zoom factor (FIG. 3, step 150). It will be appreciated that the zoom rate changes as the subject face moves to maintain a display proportion commensurate with the zoom factor. For example, if the subject face is initially located such that the face occupies only ten percent of the display space, the zoom rate is 5× zoom to achieve a fifty percent display proportion in accordance with the zoom factor. As the subject moves closer to the electronic device, a native display proportion would rise. Continuing with this example, when the native display proportion becomes 25 percent, the zoom rate automatically reduces to 2× zoom to achieve the fifty percent display proportion in accordance with the zoom factor. Zoom out functionality also may be employed. Continuing further with this example, the target subject face may move so close to the electronic device that the subject face may occupy essentially the entire (100 percent) display space. As such point, the zoom rate automatically reduces to 0.5 zoom (or zooming out effectively) to achieve the fifty percent display proportion in accordance with the zoom factor.

Although specific exemplary points in the zoom control are referenced above, it will be appreciated that the zoom control is performed gradually and continuously as the target subject moves. A smooth zoom control is therefore provided without the sudden zoom changes typical of conventional manual zoom control systems. In this manner, the auto-adjust zoom rate function adjusts the zoom rate automatically and smoothly so as to as to maintain the proportional display of the target subject matter in accordance with the zoom factor (fifty percent in this example). Such adjustments may include either zooming in or zooming out as warranted to maintain the display of the target subject face in accordance with the zoom factor.

In an alternative embodiment, a multi-tiered zoom factor may be employed, in which the zoom factor includes a first zoom factor and a second zoom factor different from the first zoom factor. For example, a first zoom factor (e.g., 50%) may be set in accordance with the above features. Subsequently, a trigger event may change the zoom factor to a second zoom factor different from the first zoom factor (e.g., 70-90%). The trigger event results in a switch from controlling the zoom function in accordance with the first zoom factor to controlling the zoom function in accordance with the second zoom factor. The trigger event may be a manual event by which the user resets the zoom factor in a manner described above, such as by providing a button, or a touch screen zoom factor input such as a two-finger pinchzoom command. Alternatively, the zoom factor may be changed automatically. In an exemplary embodiment, an automatic trigger event may be when the zoom rate reaches a predetermined zoom rate. For example, the predetermined zoom rate constituting the trigger event may be zero.

Continuing with the above example of a subject face being the target subject matter, the following describes such example in which an automatic trigger event based on a zero zoom rate alters the zoom factor. For example, suppose as above a first zoom factor is set to fifty percent, but in this altered example a second zoom factor is set to ninety percent. The user also may have entered a trigger event manually by conventional means, of a zoom rate of zero to trigger the zoom control by the controller to switch from the first zoom factor to the second zoom factor. In this example, the target subject face begins far away, such as at a native display of ten percent of the entire display space. The zoom rate, therefore, as above initially is 5× zoom. As the first zoom factor is fifty percent, the zoom is maintained such that the subject face remains displayed at fifty percent of the entire display space.

As described above, as the target subject face moves closer to the electronic camera device, the zoom rate decreases as the amount of zoom is reduced to maintain the fifty percent zoom factor. As some point, the target subject face reaches a location where the native display is the same as the zoom factor, fifty percent. At such location, the zoom rate becomes zero as no zoom is required to maintain the display of the subject face at fifty percent of the entire display space. The trigger event, zoom rate of zero, is now satisfied, and the zoom control by the controller automatically switches to control in accordance with the second zoom factor of ninety percent. Subsequent to such trigger, the zoom is controlled such that the subject face remains displayed at ninety percent of the entire display space.

Other variations may be employed to enhance the display of target subject matter using the auto-adjust zoom rate function. For example, a setting may be added to set a position of the target subject matter within the display upon application of the zoom factor, such as centered, left justified, right justified, or the like. In another variation, the face/object detection and tracking may account for other movements of the target, such as a face turning sideways relative to the camera device. The tracking would permit the zoom factor to be maintained to account for variations in movement that may not be directed in line with the electronic camera device. It will further be appreciated that the zoom operations may be performed by optical zoom, digital zoom, or combinations thereof.

It further will be appreciated that the described auto-adjust zoom rate function has significant advantages over conventional configurations. Use of the auto-adjust zoom rate function enhances the zooming operations for digital video in which the target subject matter may be moving. The auto-adjust zoom rate function provides for automatic zooming, so such function requires less precision than manual zooming which requires substantial skill to maintain the desired image size and location within the image display. Accordingly, the zoom operation of the auto-adjust zoom rate function is smooth without the sudden increases or decreases in the image display.

Referring again to FIG. 2, additional components of the electronic device or mobile telephone 10 will now be described. For the sake of brevity, generally conventional features of the mobile telephone 10 will not be described in great detail herein. The electronic device 10 may include an antenna 94 coupled to a communications circuit 96. The communications circuit 96 may include a radio frequency transmitter and receiver for transmitting and receiving signals via the antenna 94 as is conventional.

The electronic device/mobile telephone 10 may include call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia messaging service), image files, video files, audio files, ring tones, streaming audio, streaming video, data feeds (including podcasts) and so forth. Processing such data may include storing the data in the memory 90, executing applications to allow user interaction with data, displaying video and/or image content associated with the data, outputting audio sounds associated with the data and so forth.

The mobile telephone 10 further includes a sound signal processing circuit 98 for processing audio signals transmitted by and received from the communications circuit 96. Coupled to the sound processing circuit are a speaker 60 and microphone 62 that enable a user to listen and speak via the mobile telephone 10 as is conventional (see also FIG. 1).

The display 22 may be coupled to the control circuit 30 by a video processing circuit 64 that converts video data to a video signal used to drive the display. The video processing circuit 64 may include any appropriate buffers, decoders, video data processors and so forth. The video data may be generated by the control circuit 30, retrieved from a video file that is stored in the memory 90, derived from an incoming video data stream received by the communications circuit 96 or obtained by any other suitable method.

The mobile telephone 10 also may include a local wireless interface 69, such as an infrared transceiver, RF adapter, Bluetooth adapter, or similar component for establishing a wireless communication with an accessory, another mobile radio terminal, computer or another device. In embodiments of the present invention, the local wireless interface 69 may be employed as a communications circuit for short-range wireless transmission of images or image portions, tag suggestions, and/or related data among devices in relatively close proximity.

The mobile telephone 10 also may include an I/O interface 67 that permits connection to a variety of conventional I/O devices. One such device is a power charger that can be used to charge an internal power supply unit (PSU) 68. In embodiments of the present invention, I/O interface 67 may be employed as a communication circuit for wired transmission of images or image portions, tag suggestions, an/or related data between devices sharing a wired connection.

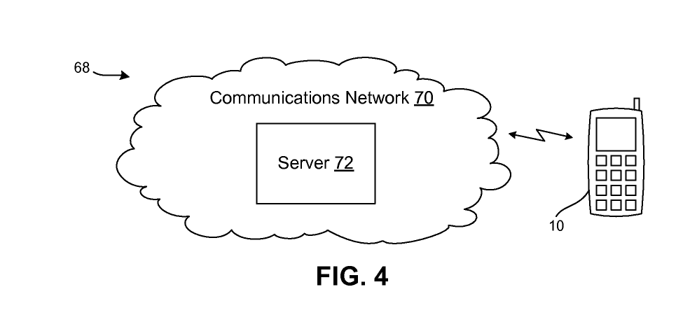

Referring to FIG. 4, the electronic device (mobile telephone) 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software.

Furthermore, as referenced above, it will be appreciated that aspects of the invention are not intended to be limited to the context of a mobile telephone and may relate to any type of appropriate electronic device having a digital video function. Any suitable electronic device may be employed.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. An electronic device comprising:
a camera assembly configured to capture a digital video;
a display for rendering the digital video; and
a controller configured to: track a target subject matter as the target subject matter moves within the digital video, receive a zoom factor corresponding to a display proportion of the target subject matter in the display relative to an entire display space of the display, and control a zoom function to render the digital video in the display such that the target subject matter is displayed in accordance with the zoom factor as the target subject matter moves within the digital video.

2. The electronic device of claim 1, further comprising an input interface configured to receive a user input of the zoom factor.

3. The electronic device of claim 2, wherein the input interface comprises a touch screen on the display, and the touch screen is configured to receive the user input of the zoom factor.

4. The electronic device of claim 3, wherein the touch screen further is configured to receive a user input identifying the target subject matter.

5. The electronic device of claim 2, wherein the input interface comprises a keypad, and the keypad is configured to receive the user input of the zoom factor.

6. The electronic device of claim 1, wherein the zoom factor is a percentage of display space of the display that the target subject matter is to occupy relative to an entire display space of the display.

7. A method of automatically performing a zoom function for a digital video comprising the steps of:
rendering a digital video in a display of an electronic device;
identifying a target subject matter in the digital video;
receiving an input of a zoom factor corresponding to a display proportion of the target subject matter in the display relative to an entire display space of the display;
tracking the target subject matter as the target subject matter moves in the digital video; and
controlling a zoom function to render the digital video in the display such that the target subject matter is displayed in accordance with the zoom factor as the target subject matter moves within the digital video.

8. The method of automatically performing a zoom function of claim 7, wherein the zoom factor is a percentage of display space of the display that the target subject matter is to occupy relative to an entire display space of the display.

9. The method of automatically performing a zoom function of claim 7, further comprising displaying an indicator on the display to indicate the target subject matter.

10. The method of automatically performing a zoom function of claim 7, wherein the zoom factor is received by setting the zoom factor independently of rendering the digital video.

11. The method of automatically performing a zoom function of claim 7, wherein the zoom factor is received by setting the zoom factor while rendering the digital video using a two-finger pinch zoom command on a touch screen display.

12. The method of automatically performing a zoom function of claim 7, wherein controlling the zoom function to render the digital video in the display such that the target subject matter is displayed in accordance with the zoom factor as the target subject matter moves within the digital video comprises automatically adjusting the zoom rate.

13. The method of automatically performing a zoom function of claim 7, wherein controlling the zoom function comprises either of zooming in or zooming out to render the digital video in the display such that the target subject matter is displayed in accordance with the zoom factor as the target subject matter moves within the digital video.

14. The method of automatically performing a zoom function of claim 7, wherein the zoom factor comprises a first zoom factor and a second zoom factor different from the first zoom factor, the method further comprising switching from controlling the zoom function in accordance with the first zoom factor to controlling the zoom function in accordance with the second zoom factor in response to a trigger event.

15. The method of automatically performing a zoom function of claim 14, wherein the trigger event is controlling the zoom function at a predefined zoom rate.

16. The method of automatically performing a zoom function of claim 15, wherein the predefined zoom rate is zero.

17. The method of automatically performing a zoom function of claim 14, wherein the first zoom factor is fifty percent of the entire display space and the second zoom factor is between seventy and ninety percent of the entire display space.

18. The method of automatically performing a zoom function of claim 7, wherein the subject matter is a face of a person, and the tracking is performed by face detection processing.

19. A non-transitory computer readable medium storing executable code which when executed by a controller performs the steps of:
rendering a digital video in a display of an electronic device;
identifying a target subject matter in the digital video;
receiving an input of a zoom factor corresponding to a display proportion of the target subject matter in the display relative to an entire display space of the display;
tracking the target subject matter as the target subject matter moves in the digital video; and
controlling a zoom function to render the digital video in the display such that the target subject matter is displayed in accordance with the zoom factor as the target subject matter moves within the digital video.

20. The non-transitory computer readable medium of claim 19, wherein the zoom factor comprises a first zoom factor and a second zoom factor different from the first zoom factor, and the controller executes the code to switch from controlling the zoom function in accordance with the first zoom factor to controlling the zoom function in accordance with the second zoom factor in response to a trigger event.
